(19) United States
(12) Patent Application Publication
(10) Pub. No.: US 2017/0004579 A1
(43) Pub. Date: Jan. 5, 2017

(54) Method to forecast future economic conditions, and to form future investment strategy

(71) Applicant: Manuel Chau, Macau (MO)

(72) Inventor: Manuel Chau, Macau (MO)

(21) Appl. No.: 15/199,991

(22) Filed: Jul. 1, 2016

(51) Int. Cl. G06Q 40/06; G06F 17/18; G06Q 10/04

(52) U.S. Cl. CPC G06Q 40/06; G06Q 10/04; G06F 17/18

(57) ABSTRACT

My invention is a method to forecast future economic conditions by one or a number of selected economic data series. By this method, economist may forecast future economic conditions and investors may improve their investment performance. This method allows a number of leading economic indicators to be used together and show signals of economic changes in an early stage.

### BACKGROUND OF THE INVENTION

Every day, a number of economic data publicized. However, it is uneasy for general public to understand their signals and to use them to forecast economic conditions. Effective, systematic, and easy understood methods are needed to convert these economic data in meaningful presentations to monitor future economic conditions. Investors also needed these methods to guide their investment strategies.

To understanding my economic forecasting method, we will discuss about Economic data, Math tools to measure statistical dispersion, and backtesting.

Economic Data

We have so many economic data publicizing every day and they all have different characteristics. Some of them are leading, which is expected to be moving ahead of the economy or a particular business sector. They have different coverages; some of them cover a wide range of things happening in the economy, and some of them represent a much smaller sector of the economy. Stock market index, prices of stocks funds or ETFs are also considered as an economic data too. They represent the prosperity of the area's economy or the business conditions of a particular business sector. Such as the S&P500 Index represents the prosperity of US's economy, the NASDAQ Index represents the business conditions the technology sector, and some ETFs for entertainment and leisure represents the business conditions of the leisure and travel industries. And some of them are given high attention as they are believed to have high co-relation with the economy. Some economic data series are more fluctuated and some are less. Economic data are presented in different formats, such as index form, some with baseline at 50, baseline at 0, or in numbers/percentages etc.

Math tools to Measure Statistical Dispersion.

For these economic data presented in so many different formats, we need math tools to measure its' statistical dispersion, which is to quantify how good/poor it is. There are many math tools that may serve this function, I would list the below math tools:

1. A constant, usually formed by a percentage of the data's range,

2. Standard deviation (SD) and moving standard deviation (Moving SD),

3. Mean of absolute differences (MAD) and moving mean of absolute differences (Moving MAD).

The simplest method to measure statistical dispersion is to use a constant, or a constant formed by a percentage of its range. Range, in a series of data, is the maximum value−(minus) the minimum value.

Standard deviation (SD) is one of the most common methods to measure statistical dispersion. In statistics, with a sample of numbers, SD's formula is the square root of the variance, and the variance is the average of the squared differences from the Mean. Please refer to FIG. 1 for formula. For ongoing data, moving standard deviation (Moving SD), or rolling standard deviation, may be used. It is to set a fixed length of data, and continually calculate its most update SD result by adding its ongoing newest data and removing the oldest data, and here, researcher has to preset the length of data, or number of periods, for this moving standard deviation calculation.

Mean absolute deviation (MAD) is another statistical dispersion measurement. In statistics, with a sample of numbers, MAD is the mean of the absolute value of each differences from their mean. For ongoing data, Moving Mean absolute deviation (Moving MAD) may be used. It is to set a fixed length of data, and continually calculate its most update MAD result by adding its ongoing newest data and removing the oldest data. (Definition of Power 2016; Standard Deviation and Variance 2016; Mean absolute deviation 2016).

Backtesting

For investors using this method on investing, we need also to understand backtesting. It is the process of testing a strategy to invest and withdraw based on data from previous time periods. Backtesting emphasis on checking the logic in strategies, it sometimes omit part of the details if it is believed not important or not significant, such as transaction cost and/or dividends income (Backtesting 2016).

### DETAILED DESCRIPTION OF THE INVENTION

Modified tools to Measure Statistical Dispersion.

Before discussing about my invention, please let me explain my modification on the math tools to measure statistical dispersion listed in the background. The math tools, discussed in the background can be a constant usually formed by a percentage of the range, Standard Deviation (SD) or moving SD, MAD/moving MAD. Except these methods, I have to modify the formula when adjusting the statistical dispersion level is required. One of this possible modifications is based on the MAD formula. I will refer these formula as the Modified Mean of absolute differences (Modified MAD) and the Modified Moving Mean of absolute differences (Modified Moving MAD). The modification is shown below:

Step 1: In the economic data series, each data's difference from their mean is taken their absolute value and is powered by y times, and y is any number.

Step 2: take the mean of step 1.

Step 3: l/z power applied (or a z th root) on the result of step 2. And either one of the y or z, or both y or z, is any number not equal to 2.

Please refer to FIG. 1 for formula of the equation. This Modified MAD formula is used when adjusting the level of deviation is required. Such as both y and z=0.7 will give a slightly smaller deviation, or both y and z=2.6 will give a higher deviation. The y and z is not equal to 2 in the same formula as it will mathematically give the same result as a standard deviation.

A Modified Moving MAD as well, is to set a fixed length of data, and continually calculating its most updated result by adding its ongoing newest data and removing the oldest data.

A summary about the discussed math tools is that, this invention requires math tools to quantify the level of data difference from its mean/moving mean, and there are abundant of math tools for this. And my modified math tool will also provide more flexibility in my invention.

Method to Forecast Economic Conditions

My invention is about using economic indicators/data to forecast future economic conditions.

We have a number of economic data publicized every day. What are these economic data signaling? Normal, good or poor? My method is, when the publicized reading is near to its mean or moving mean, represents economic conditions is normal. If the publicized reading is far above the mean or moving mean represents good economic conditions, and if the latest reading is far below the mean or moving represents poor economic conditions.

To apply this, the researcher has to preset an upper/lower range from the mean/moving mean to define good or poor. This is a question related to statistical dispersion, and can be done by using a math tool times a multiple. Therefore:

First, set a moving mean, which is averaging the data with a preset length of moving mean (Here, if infinity is set as the length represents the all lifetime data is applied in the calculation. But lifelong data are rarely used as it seldom give best results).

Then, the upper range is: the mean or moving mean+(plus) Math tool to quantify from the mean or moving mean×(times) a multiple.

And the lower range is: the mean or moving mean−(minus) Math tool to quantify from the mean or moving mean×(times) a multiple.

The math tool used here can be a variable that change according to the moving data, or ongoing data, such as the Moving SD, Moving MAD or Modified Moving MAD. The math tool used here can also be a constant, a constant formed by a percentage of the range, SD, MAD, Modified MAD.

After setting the 3 lines, moving mean, upper range, and lower range, data may fall on 4 defined sectors, which is above upper range, below lower range, upper middle range, and lower middle range. If the publicized economic data's reading is above the upper range, represents economic conditions is good. If the latest reading is below the lower range, represents economic conditions is poor. If the latest reading is between the upper and lower range, then it represents the economic conditions is normal. Here, I refer this as the middle range, the middle range is divided into 2 parts, the middle range above the data's moving mean as upper middle range, and the middle range below the data's moving mean as lower middle range. Please refer to FIG. 2, FIG. 3, FIG. 4. for chart display. This method effectively converts economic data series with different formats to a common standard. And it is much easier for general public to understand, especially when it is shown in a chart. For some economic data series that are negatively correlated to the economy, in this method, are to be inverted by multiplying with −1 (negative one). Example of these series are the St. Louis Fed Financial Stress Index (or STLFSI) or the Initial Claims data (ICSA).

To illustrate this, example is shown in FIG. 2, FIG. 3, FIG. 4, which is an illustration for using this method on economic data with different formats to show how it defines economic conditions, which include:

1. ISM Manufacturing: PMI Composite Index (NAPM)

2. United States Seasonally Adjusted Personal Consumption Expenditures on Durable Goods, monthly Percent Change from a Year Ago (PCEDG)

3. And Leading Index for the United States, Percent, Monthly, Seasonally Adjusted (USSLIND)

The economic data series have set both upper/lower range with positive/negative 0.9 times by its 6 month moving SD from its 6 month moving mean. If the publicized reading is above the upper range, economic condition is considered good, and if the publicized reading is below its lower range, economic condition is considered poor.

Since this method effectively convert economic data series with different formats to a common standard, a number of economic data series with different formats may be applied together to measure economic conditions. This idea is important for economic research as it was difficult to put a number of economic indicators with different formats together. For my method to forecast future economic conditions, researcher may select a number of economic data series with below criteria:

1. Related to the economy

The economic data are related to the economy, or believed to have high Correlation or predictability for future economic conditions.

2. The data is moving ahead of the economy

The economic data showed properties of leading economic indicators, which is expected to be moving ahead of the economy or a particular business sector. The data is at least not lagging the economy.

3. Wide Coverage

The economic data covered a wide range of things happening in the economy. If the data showed small coverage, then a multiple economic data series that each represents a different coverage in the economy have to be selected together.

Forecasting the economy is possible when most of the selected economic data process these properties. By applying these economic data into the invention, when a high number/percentage of these selected economic data is above its preset upper range, maybe consecutively in several periods, represents good economic conditions is ahead. When high number/percentage of these selected economic data is below its preset lower range, maybe consecutively in several periods, represents poor economic conditions are ahead.

The economic data above upper range, or below lower range, may be measured by numbers or by percentage. Measurement by percentage allows the number of economic data series used to be changeable with less modification on the measurement process. In case the total number of economic data series used remains unchanged within the measurement period, it will mathematical create the same results for both measurement of numbers or percentage.

To illustrate this, an example is shown in FIG. 5, which is an illustration of my own 10 selected economic data series designated to forecast economic conditions by the invention. My selected economic data series used is shown in FIG. 8. 35 years data is used from 1980 to 2015. The chart shows the percentage of selected economic data series consecutively 3 months above/below its upper/lower range, where upper and lower range is defined by +and −0.5 times by its 6 month moving SD from its 6 month moving mean. To make the percentage more readable on the chart, it is smoothed by 3 month moving average. If it is not made consecutively and is smoothed with 3 month moving average, it will show more leading properties but more fluctuated. The chart shows the percentage readings are changing before the US GDP turning points. FIG. 6 shows the percentage of selected economic data series consecutively 3 months below its lower range, comparing with the US GDP consecutively decreasing for 2 quarters. This shows when a high number of selected economic data below its lower range is predictable of the down trend of US GDP.

Method to Form Future Investment Strategies.

This invention can assist in forming future investment strategies. Since stock/fund prices are likely to appreciate when economic conditions is good ahead, which is a signaled by a single/or a number of economic series above its higher range. Similarly, stock/fund prices are likely to depreciate when economic conditions is poor ahead, which is a signaled by a single/or a number of economic series below its lower range. In other words, when a single or a high number of economic series below its lower range, it represents poor economic conditions is ahead, gives sell signal. When a single/or a number of economic series above its higher range, it represents good economic conditions is ahead, gives buy signal.

FIG. 7, is an illustration of my own 10 selected economic data series is also good to forecast S&P500 Index. The chart visually displayed from 1999 to 2015. My selected economic data series used is the same as the data previously used and is shown in FIG. 8.

The researcher may carry out backtests, with different settings on investment logic based on this method, a target stock or fund to invest, length for moving mean, math tool to be used, and its multiplication. As discussed, when a single or a high number of economic series below its lower range, it represents poor economic conditions is ahead, gives sell signal. When a single/or a number of economic series above its higher range, it represents good economic conditions is ahead, gives buy signal. It may also be understood by another way. When a single, or a number of, economic series move from below its lower range back to the normal, may give buy signal. Or when a single, or a number of, economic series move from above its upper range back to normal, may give sell signal. And when working these signals with backtest of stocks or funds, it may depends on the characteristics of the stocks or funds movement itself. I would recommend below steps to create backtests.

Step 1: Researcher has to set investing strategy and a target stock/fund/market index to invest.

Step 2: Researcher has to set economic data series to be tested, the length for moving mean, and the definition of the upper/lower range, created by selecting a math tool and its multiplication.

Step 3: Compare the results in terms of profitability.

Step 4: Concluding the results, if the results is satisfactory, the researcher may set as a future investment strategy. If the logic is not satisfactory, researcher may adjust part of the test, or reset everything to run all the steps again.

To illustrate this, please find the below example:

Investment strategy generated by 1 single economic data series, which buy/hold all the times except that economic data series latest publicized that month is below its lower range. The economic data series used, length for moving mean, definition of the upper/lower range will be backtested to optimize a future investment strategy. The target stock/fund/stock market index is S&P500, and time frame is from 2001 January to 2015 Dec. Starting capital is set at $1000. After a number of backtest, the Leading Index for the United States (USSLIND) shows the best results as the data series. Please find the results of the below settings.

If Moving MAD used as the math tool, the best result is at length of moving period=4 month,

Multiply=0.7, gives investment result of $2533.2 in 15 years backtest.

If Moving SD used as the math tool, the best result is at length of moving period=4 month, Multiply=0.7, gives investment result of $2520.1 in 15 years backtest.

If Modified Moving MAD used as the math tool, the best result is at y and z both=0.7, length of moving period=4 month, multiply=0.8, gives highest result of $2577.2 in 15 years backtest. Results of this setting is shown in FIG. 9.

### REFERENCES

### Patent Citations

Lu, Jizhu. Iteratively calculating standard deviation for streamed data U.S. Pat. No. 9,069,726 B2, Jun. 30, 2015

### Non-Patent Citations

Definition of Power, Available from: <https://www.mathsisfun.com/definitions/power.html>. [No dated, retrieved on 22 Jun. 2016].

Standard Deviation and Variance, Available from: <http://www.mathsisfun.com/data/standard-deviation.html>. [No dated, retrieved on 22 Jun. 2016].

Measures of Spread, Available from: <https://statistics.laerd.com/statistical-guides/measures-of-spread-range-quartiles.php>. [No dated, retrieved on 22 Jun. 2016].

Mean absolute deviation (MAD), Available from: <https://www.khanacademy.org/math/cc-sixth-grade-math/cc-6th-data-statistics/cc-6-mad/v/mean-absolute-deviation>. [No dated, retrieved on 22 Jun. 2016].

Backtesting, no author, Available from: http://www.investopedia.com/terms/b/backtesting.asp [No dated, retrieved on 22 Jun. 2016].

### BRIEF DESCRIPTION OF THE DRAWINGS

FIG. 1 is the math formulas for the Standard deviation (SD), Mean of absolute differences (MAD), and my Modified Mean of absolute differences (MAD).

FIG. 2 is a chart to show the method to display of the economic data series, its moving mean, its upper range and its lower range in a same chart to identify different economic conditions. This chart used the ISM Manufacturing: PMI Composite Index (NAPM).

FIG. 3 is a chart to show the data series of United States Seasonally Adjusted Personal Consumption Expenditures on Durable Goods, monthly Percent Change from Year Ago (PCEDG), its moving mean, its upper range and its lower range in a same chart to identify different economic conditions.

FIG. 4 is a chart to show Leading IH(16X for the United States, Percent, Monthly, Seasonally Adjusted (USSLIND), its moving mean, its upper range and its lower range in a same chart to identify different economic conditions.

FIG. 5 is a chart to show different month's percentage of selected economic series data's reading is above its upper range and below its lower range. The selection of economic indicators are displayed in FIG. 8. It is compared with the US Quarter GDP.

FIG. 6 is a chart to show different month's percentage of selected economic series data's reading is below its lower range compared with the US Quarter GDP consecutively decreasing for 2 quarters. The selection of economic indicators are displayed in FIG. 8.

FIG. 7 is a chart to show different month's percentage of selected economic series data's reading is above its upper range and below its lower range. The selection of economic indicators are displayed in FIG. 8. It is compared with the S&P500 Index Percentage change from a year ago.

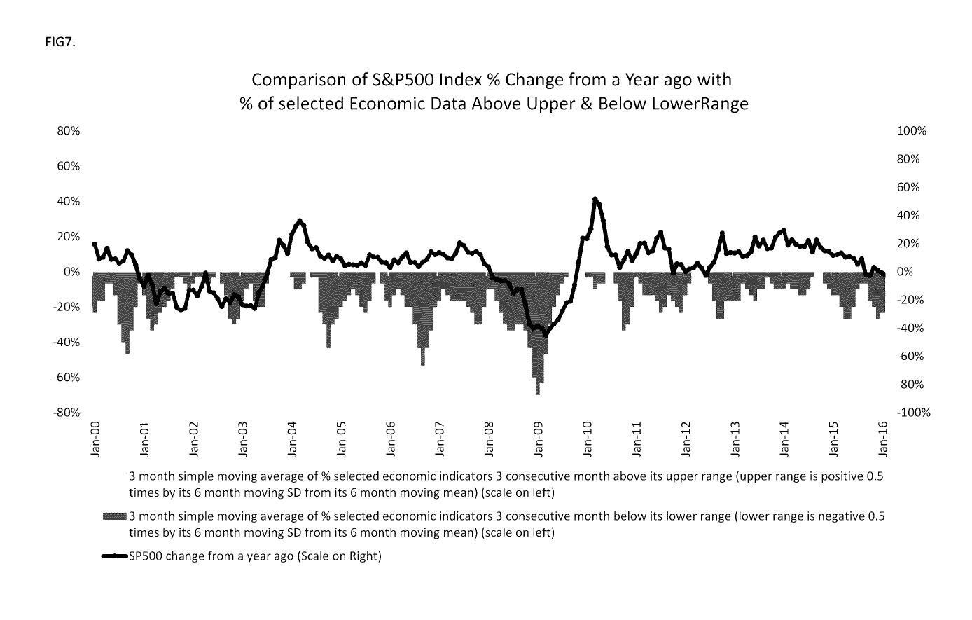

FIG. 8 is a list to display the selected economic data series used in FIG. 5, FIG. 6 and FIG. 7.

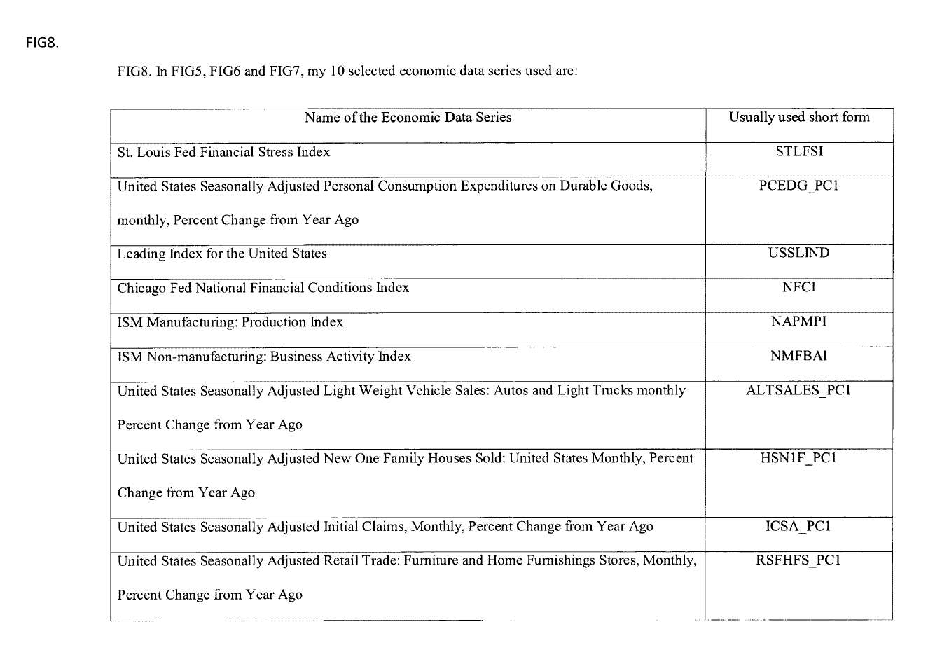

FIG. 9 is a chart to show the backtesting results of an investment strategy generated by 1 single economic data series, which buy/hold all the times except that economic data series latest publicized that month is below its lower range. The target is a stock market index S&P500, and time frame is from 2001 January to 2015 December.

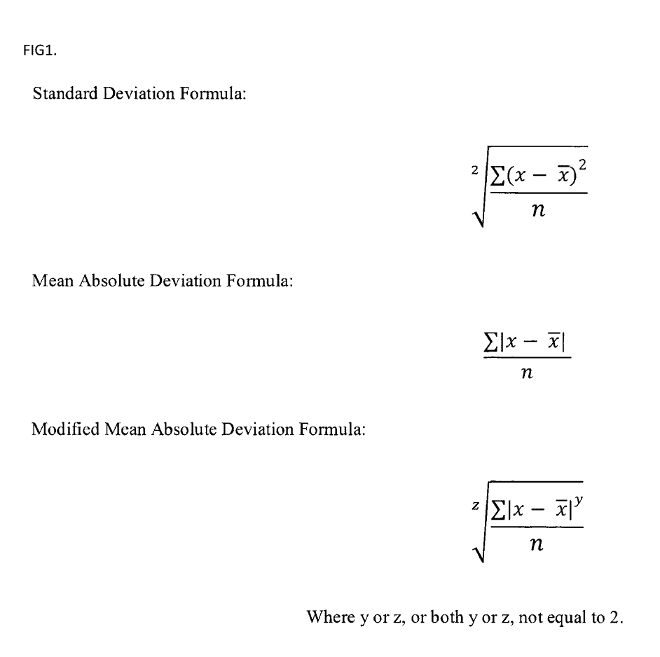

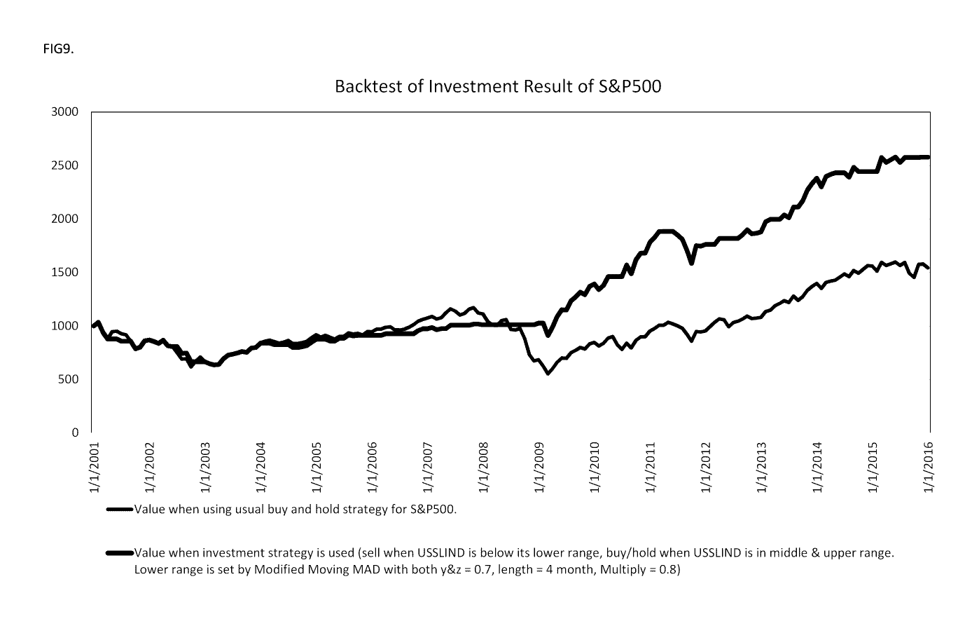

1. In statistics measurement, a method is Modified Mean of absolute differences (Modified MAD). The formula is shown in FIG. 1. The steps of calculation is below:
Step 1: In a number of data, each data's difference from their mean is taken their absolute value and is powered by y times, and y is any number.
Step 2: take the mean of step 1.
Step 3: l/z power (or a z th root) is applied on the result of step 2. And either one of the y or z, or both y or z, is any number not equal to 2.

2. Referring to Modified MAD discussed in claim 1, Modified Moving Mean of absolute differences (Modified Moving MAD) is continually calculating Modified MAD's most updated result by adding its ongoing newest data and removing the oldest data. Here, the researcher has to preset a number of periods for the Modified Moving MAD.

3. Method for data series to form its upper range and lower range, and define into sectors of above upper range, below lower range, and middle range.
Here, the researcher has to set the math tool, the number of periods if ongoing data (or rolling data), and multiple used.
The moving mean is the result of averaging the data within the number of periods.
The upper range is the data series' moving mean plus a math tool times a multiple.
The lower range is the data series' moving mean minus a math tool times a multiple.
With the above lines, the data may fall on 4 sectors, above upper range sector, upper middle sector, lower middle sector, and below lower range sector.

4. Referring to the math tool stated in claim 3, a constant, or a constant formed by a percentage of its range can be used as the math tool.

5. Referring to the math tool stated in claim 3, Standard Deviation (SD) can be used as the math tool.

6. Referring to the math tool stated in claim 3, Moving Standard Deviation (moving SD) can be used as the math tool.

7. Referring to the math tool stated in claim 3, Mean of absolute differences (MAD) can be used as the math tool.

8. Referring to the math tool stated in claim 3, Moving Mean of absolute differences (Moving MAD) can be used as the math tool.

9. Referring to the math tool stated in claim 3, my modified formula stated in claim 1, the Modified Mean of absolute differences (Modified MAD) can be used as the math tool.

10. Referring to the math tool stated in claim 3, my modified formula stated in claim 2, the Modified Moving Mean of absolute differences (Modified Moving MAD) can be used as the math tool.

11. The definition of good, poor, normal economic conditions when economic data is applied in the creation of upper/lower ranges by method stated in claim 3.
If the economic data is above the upper range, represents economic conditions is good
If the economic data is below the lower range, represents economic conditions is poor.
If the economic data is in the middle range, or between the upper and lower range, economic conditions is normal.

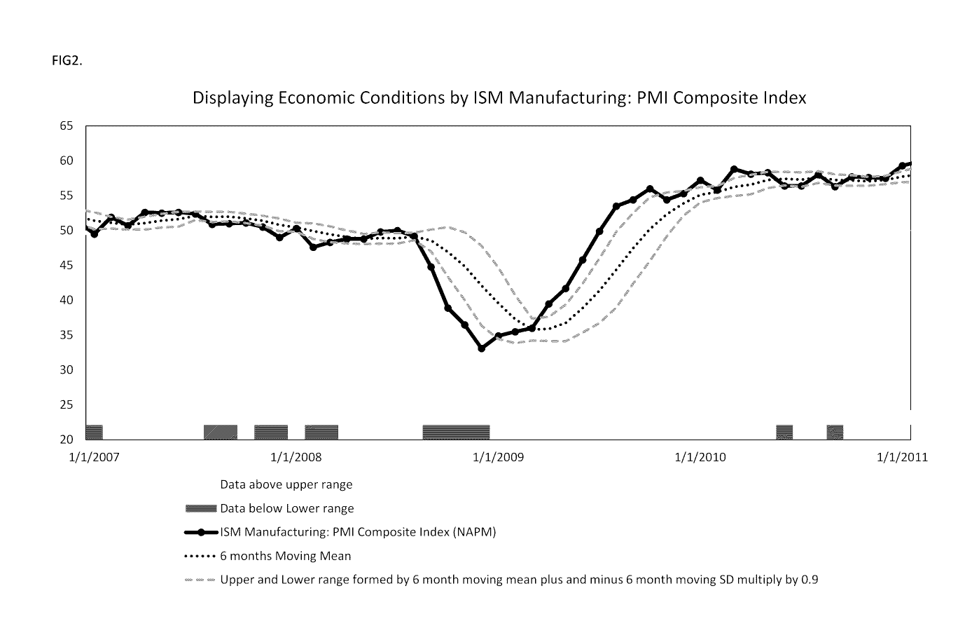

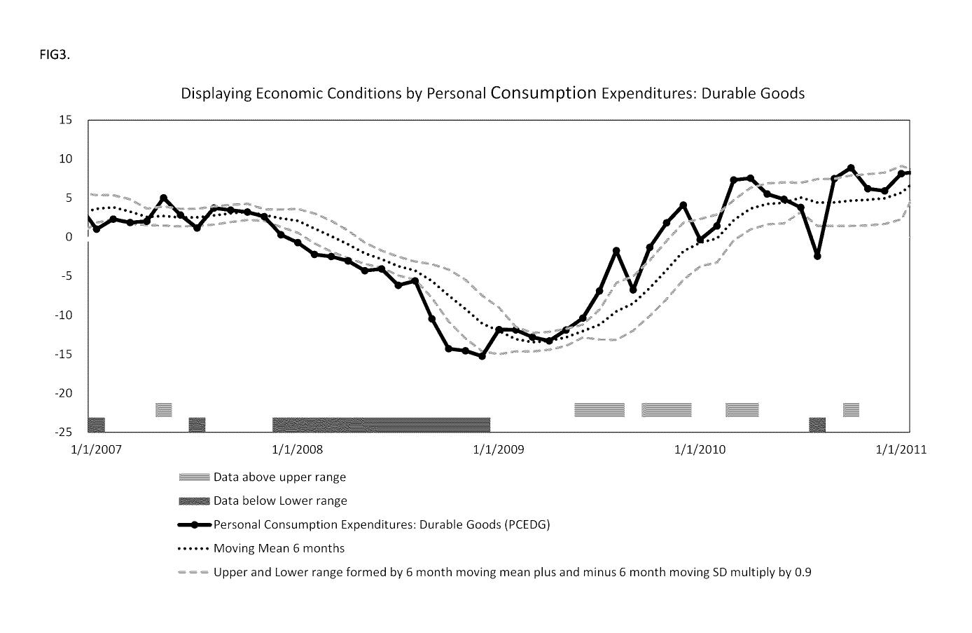

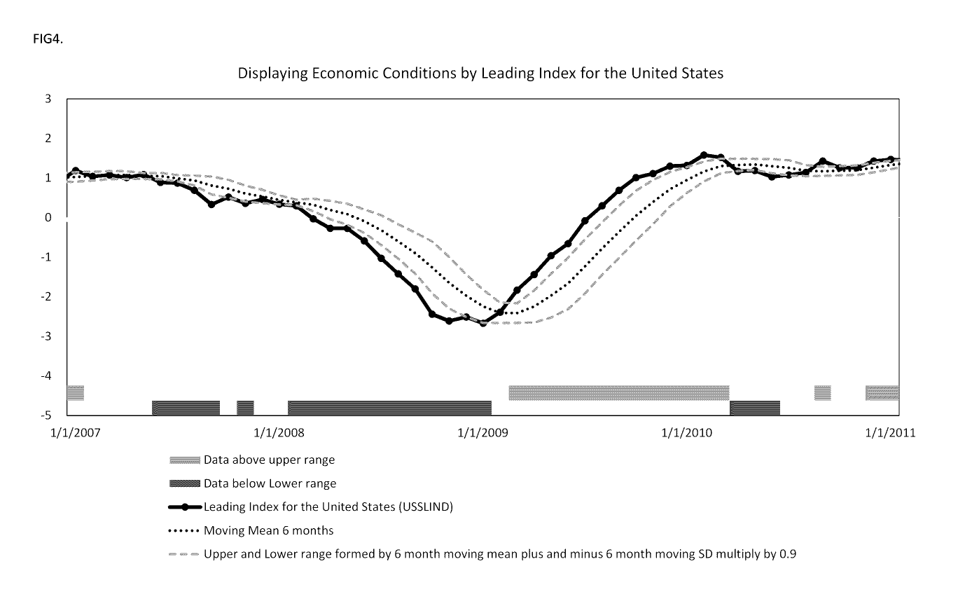

12. When economic data is applied in the creation of ranges by method stated in claim 3, the display of components mentioned in claim 3 in a same chart to identify different economic conditions. Please also refer to FIG. 2, FIG. 3, FIG. 4.

13. When more than one economic data is applied in the creation of ranges by method stated in claim 3, counting, aggregating, or summing up a period's number of economic data series' reading falls on each range. Such as, counting or aggregating the number or percentage of data in the above upper range, upper middle range, lower middle range, or the below lower range.

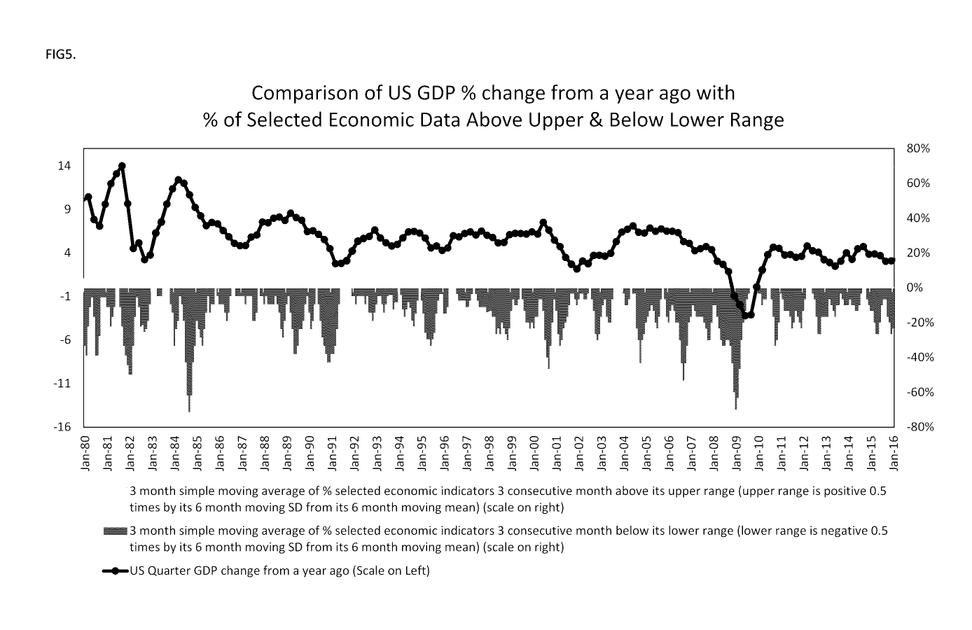

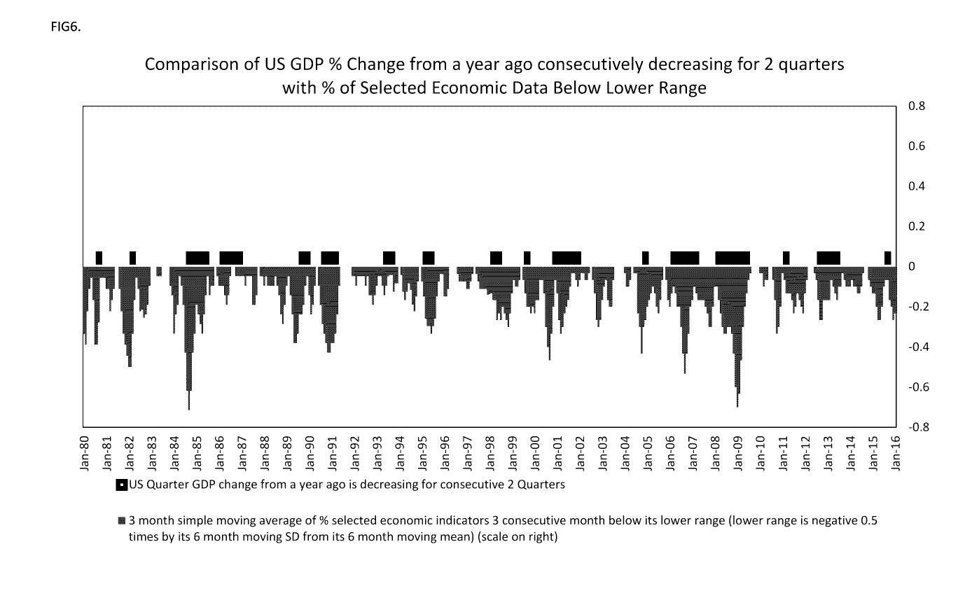

14. When more than one economic data is applied in the creation of ranges by method stated in claim 3, displaying the count or total result of economic data series' reading falls on different ranges in terms of total number or in percentage. Please also refer to FIG. 5, FIG. 6.

14. When a single or a number of economic data is applied in the creation of ranges by method stated in claim 3, forming buy/sell signals or recommendation of buy/sell of stocks or funds by a single reading, or an aggregated reading, of economic data falls on different ranges.

15. When a single or a number of economic data is applied in the creation of ranges by method stated in claim 3, using the reading of economic data falls on different ranges as a component of the backtest of stocks or funds, or forming additional technical indicators.
